(19) United States
(12) Patent Application Publication
(10) Pub. No.: US 2015/0379233 A1
(43) Pub. Date: Dec. 31, 2015

(54) METHOD, APPARATUS, AND COMPUTER-READABLE MEDIUM FOR DETERMINING A TARGET GEOGRAPHIC AREA FOR A TARGET DRUG

(71) Applicant: Physicians Interactive, Inc., Reading, MA (US)

(72) Inventor: Patrick Charles Aysseh, Stamford, CT (US)

(73) Assignee: Physicians Interactive, Inc., Reading, MA (US)

(21) Appl. No.: 14/320,347

(22) Filed: Jun. 30, 2014

(51) Int. Cl. G06F 19/00; G06Q 30/02

(52) U.S. Cl. CPC G06F 19/3456; G06Q 30/0205; G06Q 30/0246; G06Q 30/0261

(57) ABSTRACT

An apparatus, computer-readable medium, and computer-implemented method for determining a target geographic area corresponding to a target drug includes receiving health condition information for a plurality of geographic areas, the health condition information including information regarding one or more health conditions of residents in each of the plurality of geographic areas, receiving healthcare plan information corresponding to each geographic area in the plurality of geographic areas, the healthcare plan information including formulary information corresponding to at least a subset of the residents in each of the plurality of geographic areas, the formulary information specifying the availability of one or more of drugs, determining the target geographic area for the target drug from the plurality of geographic areas, wherein the target geographic area is determined based at least in part on a combination of the health condition information and the formulary information, and transmitting a representation of the target geographic area.

### BACKGROUND

Healthcare information drives the goals and practices of many different categories of healthcare participants. These include pharmaceutical companies looking to raise awareness of newly launched products or to raise market share for established brands; health insurance companies who are participating in state-run public exchanges, as a result of the Affordable Care Act, and who need to raise awareness of their services among the uninsured; and retail and pharmacy chains who are looking for local area competitive positioning and who want to drive increased repeat business.

Unfortunately, there is currently no way to leverage healthcare information to achieve the goals of participants on a broad scale, such as through mobile advertising to potential customers.

### BRIEF DESCRIPTION OF THE DRAWINGS

FIG. 1 illustrates a flowchart for determining a target geographic area for a target drug according to an exemplary embodiment.

FIG. 2 illustrates a flowchart for identifying potential target geographic areas according to an exemplary embodiment

FIG. 3 illustrates another flowchart for identifying potential target geographic areas according to an exemplary embodiment.

FIG. 4 illustrates a flowchart for designating a potential target geographic area as the target geographic area according to an exemplary embodiment.

FIG. 5 illustrates example process flows for designating potential target geographic areas as target geographic according to an exemplary embodiment.

FIGS. 6A-6C illustrate user interfaces for determining a target geographic area for a target drug according to an exemplary embodiment.

FIGS. 7A-7F illustrate additional user interfaces for determining a target geographic area for a target drug according to an exemplary embodiment.

FIG. 8 illustrates a block diagram of the data import process according to an exemplary embodiment.

FIG. 9 illustrates a block diagram of the user interface processes according to an exemplary embodiment.

FIG. 10 illustrates an exemplary computing environment that can be used to carry out the method for determining a target geographic area for a target drug according to an exemplary embodiment.

### DETAILED DESCRIPTION

While methods, apparatuses, and computer-readable media are described herein by way of examples and embodiments, those skilled in the art recognize that methods, apparatuses, and computer-readable media for targeting pharmaceutical advertisements are not limited to the embodiments or drawings described. It should be understood that the drawings and description are not intended to be limited to the particular form disclosed. Rather, the intention is to cover all modifications, equivalents and alternatives falling within the spirit and scope of the disclosure. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Applicants have discovered a way of targeting pharmaceutical advertisements which leverages geographically-referenced health condition and/or health prevalence data and geographically-referenced healthcare plan information, including formulary information corresponding to healthcare plans, to target advertisements for a target drug in a target geographic area.

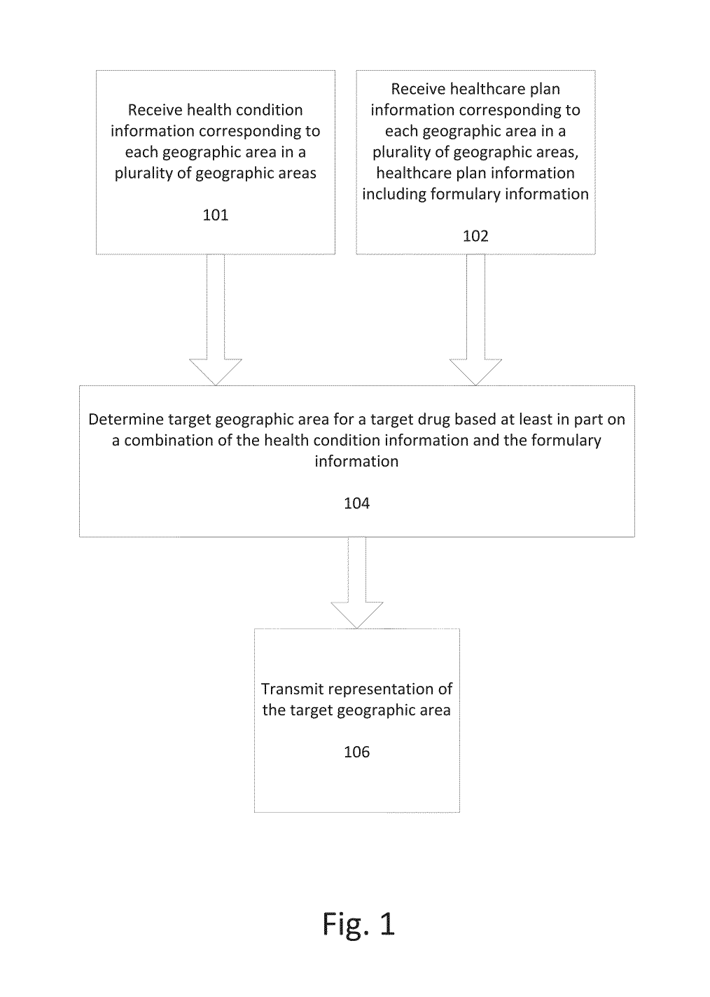

FIG. 1 is flowchart showing a method of determining a target geographic area for a target drug according to an exemplary embodiment. At step 101 health condition information for a plurality of geographic areas is received. The health condition information includes information regarding health conditions of residents in each of the plurality of geographic areas. The health condition information can include information related to diseases, ailments, health measurements, and/or risk factors. For example, the health condition can be diabetes, smoking, high blood pressure, insomnia, obesity, etc. Health condition information can be derived or otherwise gathered or filtered from healthcare data, such as prescriptions for particular drugs or types of drugs.

At step 102, healthcare plan information corresponding to each geographic area in the plurality of geographic areas is received. The healthcare plan information can include information regarding healthcare plans corresponding to residents in each of the geographic areas. For example, the healthcare plan information can include the plan provider and/or plan type for residents in each of the geographic areas. The healthcare plan information includes formulary information corresponding to at least a subset of the residents in each of the plurality of geographic areas, the formulary information specifying the availability of one or more of drugs. For example, the healthcare plan information can be the percentage of residents in each geographic area that are eligible for a particular drug. This percentage can take into account the formulary information associated with the healthcare plans for the residents in each geographic area.

The formulary information can include a list of generic and brand name drugs that are preferred by the healthcare plans in the healthcare plan information and can specify the availability of one or more drugs. For example, the formulary information can specify the availability of one or more drugs for each of the healthcare plans in the healthcare plan information. The formulary information can also include additional data such as copay costs for assorted drugs, provider costs, patient costs, etc.

The formulary information can include multiple lists, or tiers, of drugs and corresponding coverage amounts for each list, or tier. For example, the formulary information can specify that Healthcare Prescription Plan XYZ has four tiers of drugs with varying levels of coverage. Tier 1 drugs may be completely paid for by the insurance provider with no out-of-pocket costs for the patient. Tier 2 drugs may require a co-payment of 10% of the price of the drug. Tier 3 drugs may require a co-payment of 50% of the price of the drug. Tier 4 drugs may be completely uncovered and require full payment by the patient. Many variations are possible, and these examples are not intended to be limiting. Formulary information can also include drug classes and specify generic versions of various drugs, which can fall into different tiers than name-brand versions. The formulary information can include formulary information which has not been implemented yet but which is scheduled to be implemented in the future. For example, the formulary information can include a list of changes for the upcoming year or other future period of time.

At step 104, a target geographic area for a target drug is determined based at least in part on a combination of the health condition information and the formulary information. Additionally, multiple target geographic areas for multiple target drugs can be determined based at least in part on a combination of the health condition information and the formulary information. For example, if each of the geographic areas are states, and the target drug is Ambien™, then an analysis of the share of market of Ambien™ in each state can be conducted to identify states where demand is high but share of market is low. If those states include New York and Texas, then the resulting target geographic areas and target drugs can be, for example, Texas:Ambien, New York:Ambien, etc.

The target drug can be selected or entered by a user, or can be automatically determined based on a combination of the health condition information and the formulary information.

At step 105, a representation of the target geographic area for the target drug is transmitted. This representation can include any combination of textual and graphical elements. For example, a map can be transmitted with the target geographic area (or areas) highlighted, colored, or otherwise emphasized. Additionally or alternatively, a list including the target geographic area (or multiple target geographic areas can be transmitted).

Additionally, an advertisement for the target drug can be transmitted to one or more potential consumers of the target geographic area. Potential consumers can include individuals in a target geographic area, residents of the target geographic area, medical professionals who do business the target geographic area, such as doctors or nurses, or any other persons with ties to the target geographic area. The advertisement can be transmitted to devices of the potential consumers, such as in a mobile application or mobile web page on a mobile device, a browser web page on a computing device, or through some other means of communication, such as text message or email. Additionally, the potential consumers in the target geographic area can be selected based on demographic information, such as age, gender, income, location of residence within the geographic area, proximity to a doctor's office, proximity to a pharmacy, current location, etc. Additionally, results of previous advertisements or ad campaigns can be utilized to adjust or modify the determination of target geographic areas or ad delivery. For example, the results of a previous campaign for a specific target drug can be used to improve targeting of ads for that target drug in the future.

Each geographic area in the plurality of geographic areas can correspond to one or more of a state, a county, a zip code, a city, an address, a facility, or any other unit of area or geographical indicator. Optionally, a user can select how to define the geographic areas, such as through a user interface. Additionally, multiple tiers of geographic areas can be defined depending on user preferences and outlook for the marketing campaign. For example, a user can view a national map in which each of geographic areas corresponds to a state. After selecting a state, the user can view a state map in which each of the geographic areas corresponds to a county, and so on.

The target geographic area for the target drug can also be determined based on the total number of available ad impressions for each geographic area. For example, if an urban area offers a higher total number of available ad impressions than an otherwise comparable rural area, then the urban area can be selected as the target geographic area.

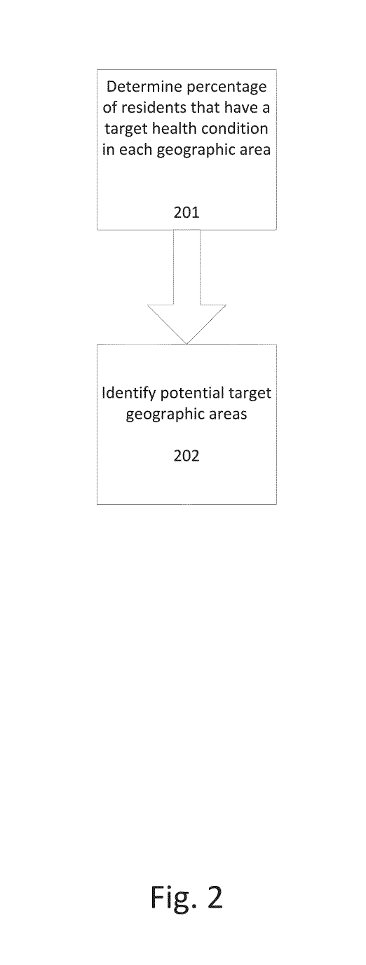

FIG. 2 is flowchart showing a method for determining a target geographic area from the plurality of geographic areas according to an exemplary embodiment. At step 201 the percentage of residents that have a target health condition in each geographic area is determined. The target health condition can be provided by a user via user interface or can be based on the target drug. For example, a target health condition can be selected such that the target drug is designed to treat the target health condition or a target health condition can be automatically determined based on a selection of a target drug. Alternatively, a target health condition can be selected and a target drug can be identified based on a determination that the target drug is designed to treat the target health condition. Multiple target drugs can be selected. Additionally, target drugs can be identified or further filtered based availability of the drug, accessibility of the drug to residents in each geographic area based on healthcare plans (as will be later described), drug side-effects, costs, or any other relevant metric.

Additionally, step 201 can include evaluating the percentage of residents that have various potential target health conditions. These potential target health conditions can be provided by the user or automatically generated based on received health prevalence and health condition data. Additionally, different numerical metrics can be used in addition to or in place of a percentage. For example, a health condition prevalence index can be computed for each geographic area.

At step 202, potential target geographic areas are identified. The potential target geographic areas can be identified based on the percentages (or other numerical metrics) for each geographic area. A geographic area can be identified as a potential target geographic area based at least in part on a determination that the corresponding percentage of residents that have the target health condition for that geographic area is greater than a predetermined threshold. Alternatively, if the numeral metric is an index, a geographic area can be identified as a potential target geographic area based at least in part on a determination that the health condition index is greater than a predetermined threshold. The predetermined threshold can be provided by a user through a user interface or can be automatically determined depending on the target health condition.

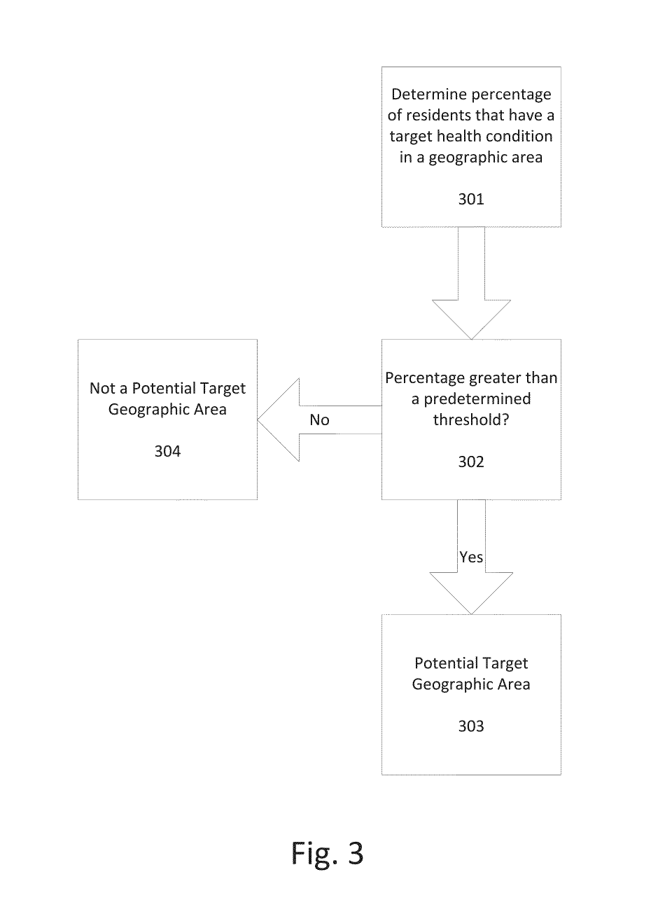

For example, as shown in FIG. 3, at step 301, the percentage of residents that have a target health condition is determined for a candidate geographic area. At steps 302, this percentage is compared to a predetermined threshold to determine whether it is greater than the predetermined threshold. If the percentage is not greater than the predetermined threshold, then the geographic area can be set aside or designated as not a potential target geographic area, as shown at step 304. If the percentage is greater than the predetermined threshold, then the geographic area can be added to the list of potential target geographic areas, as shown at step 303.

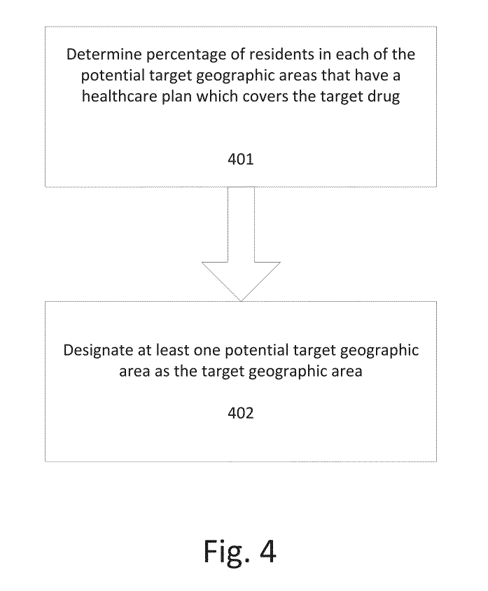

FIG. 4 is flowchart showing a method for determining a target geographic area from the plurality of potential target geographic areas according to an exemplary embodiment. At step 401 the percentage of residents in each of the potential target geographic areas that have a healthcare plan which covers (or partially covers) the target drug is determined. This determination can be based on the formulary information. Additionally, different numerical metrics can be used in addition to or in place of a percentage. For example, a healthcare plan coverage index can be computed for each geographic area.

At step 402 at least one of the potential target geographic areas is designated as the target geographic area for the target drug. This designation of a target geographic area can based at least in part on a determination that the corresponding percentage of residents that have a healthcare plan which covers the target drug for that geographic area is greater than a predetermined threshold. Alternatively, if the numeral metric is an index, a geographic area can be identified as a potential target geographic area based at least in part on a determination that the health condition index is greater than a predetermined threshold.

The predetermined threshold can be provided by the user via a user interface. For example, a user can indicate that they are only interested in geographic areas where greater than 75% of the population has coverage for a particular drug. Additionally, coverage can include full or partial coverage, such as partial coverage which requires a healthcare plan beneficiary to provide a copayment for the drug. Users can customize the criteria for selecting a target geographic area based on healthcare plan information and the target drug, such as by specifying that residents whose out-of-pocket costs for the target drug are below a predetermined amount should be considered covered residents. Coverage does not require that all of the costs of a particular drug are covered by the insurance provider, and the definition of coverage can be customized by the user. Using the earlier example of a prescription plan with four tiers of coverage, a user can specify that they consider coverage to be any drugs that fall within the first two tiers (either free or a 10% co-payment). Alternatively, coverage can be defined based on out-of-pocket costs, such that drugs which have associated out-of-pocket costs less than a predetermined amount are considered to be covered. This predetermined amount can be user-defined.

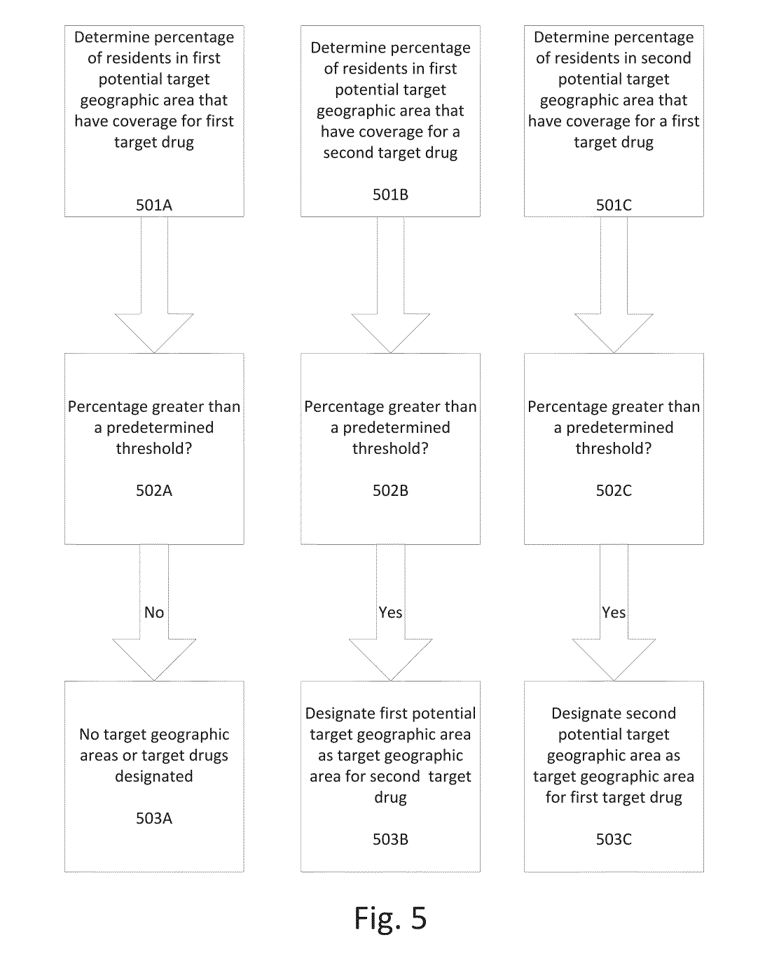

FIG. 5 illustrates a flowchart showing different combinations of target geographic areas and target drugs, as well as different outcomes depending on the percentage of residents in the relevant geographic areas that have coverage for the target drugs. At step 501A the percentage of residents in a first potential target geographic area that have coverage for a first target drug is determined. At step 502A it is determined whether the percentage is greater than a predetermined threshold. If the percentage is not greater than the predetermined threshold, then no target geographic areas are designated, as shown at step 503A.

As discussed earlier, it is possible to have more than one target drug which is designed to treat the target health condition. The healthcare coverage percentage for the additional target drugs can be determined as well. Turning to FIG. 5, at step 501B the percentage of residents in a first potential target geographic area having coverage for a second target drug is determined. At step 502B it is determined whether the percentage is greater than a predetermined threshold. If the percentage is greater than the predetermined threshold, then the first potential geographic area is designated as a target geographic area for the second target drug, as shown at step 503B.

Additionally, it is also possible that a second potential target geographic area meets the requirements for a target drug where a first potential target geographic area did not. Returning to FIG. 5, at step 501C the percentage of residents in a second potential target geographic area that have coverage for the first target drug is determined. At step 502C it is determined whether the percentage is greater than a predetermined threshold. If the percentage is greater than the predetermined threshold, then the second potential geographic area is designated as a target geographic area for the first target drug, as shown at step 503C.

One or more user interfaces can be presented to the user to allow them to make selections, enter thresholds or criteria, filter or select the data received and organized by the system, and perform the steps described in the above-mentioned methods. For example, a map of the plurality of geographic areas can be transmitted to the user including indicators corresponding to assorted geo-referenced data, such as the percentage of residents in each area that have a particular health condition, or the percentage of residents in each area that have healthcare coverage for a particular drug.

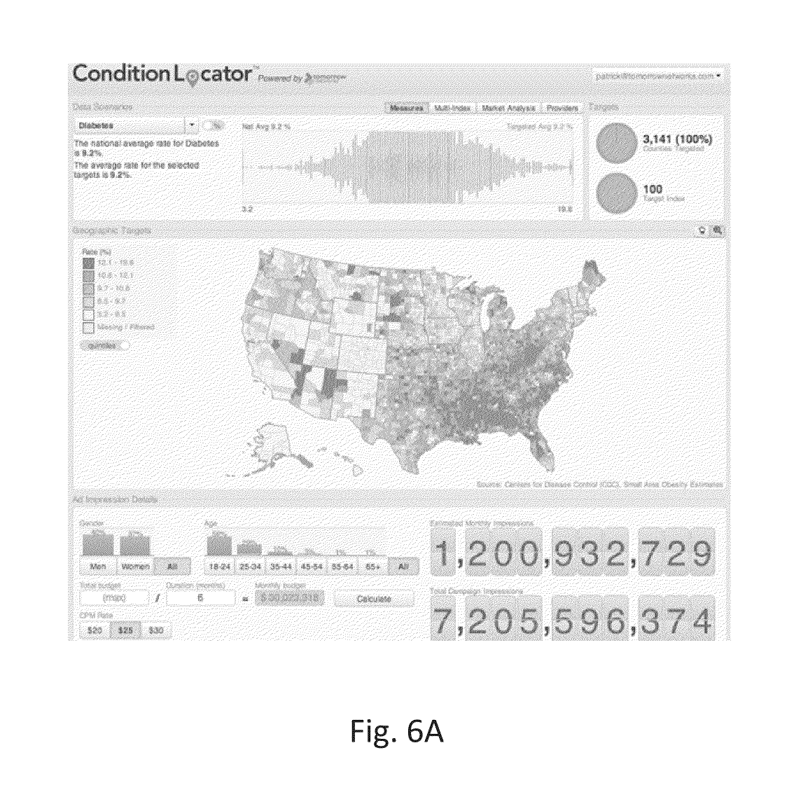

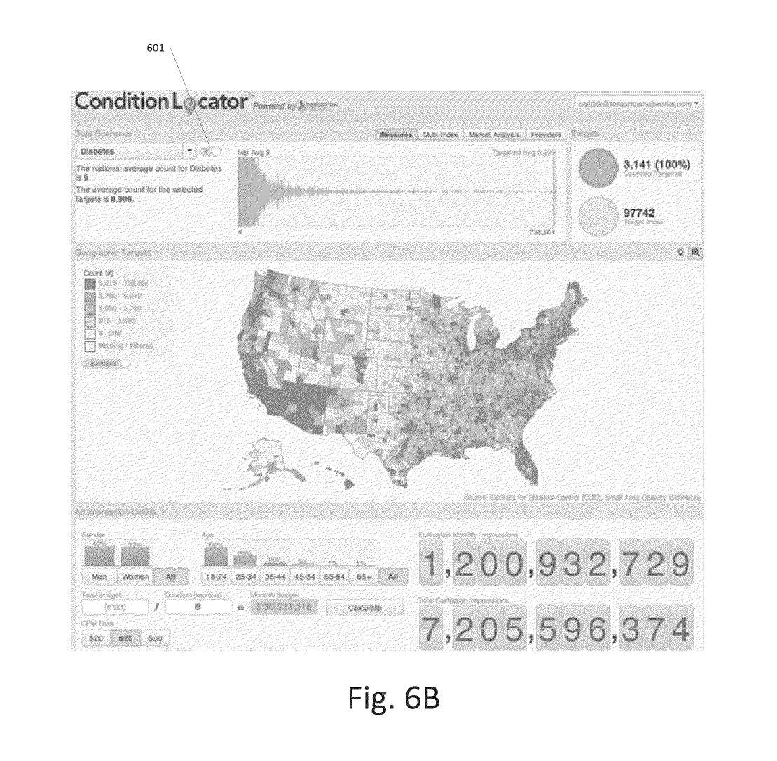

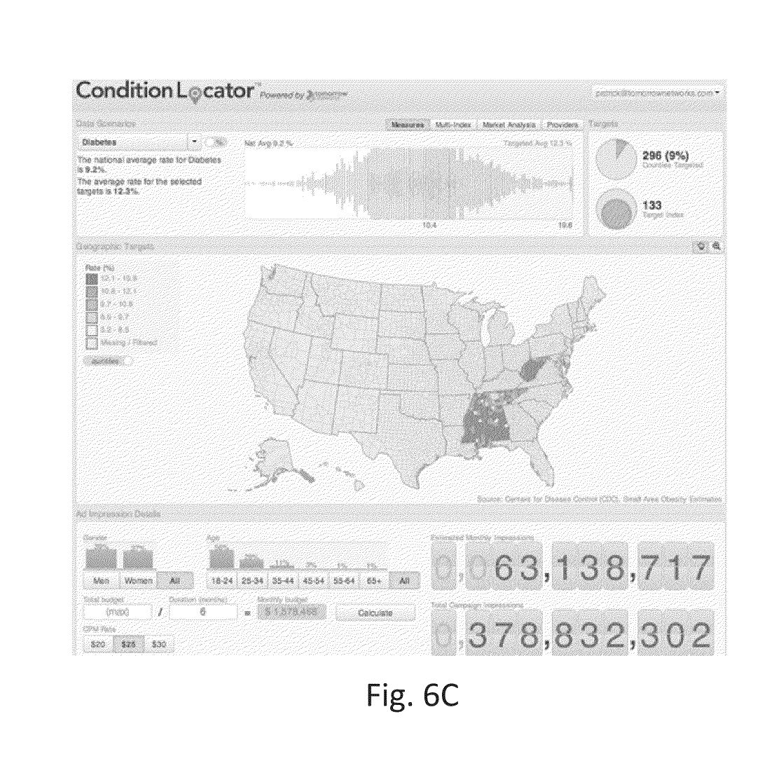

FIG. 6A illustrates a user interface of the system according to an exemplary embodiment. As shown, the interface can default to loading to a “measures” scenario (currently shown with the health condition diabetes, but another measure could also be default). Hovering over the name of the measure can show a drop down menu that allows the user to select from the hierarchical assortment of available measures. The user can select between rates and absolutes for display, and, if the data has exact locations (e.g. doctors' offices) then they can also specify they should be shown on the map through the interface. Captions for measures can explain the averages, and outliers with a little bit of detail. The data can also be annotated and stored with notes or other observations, such as “xxx” people suffer from YYY.

FIG. 6B illustrates another user interface of the system according to an exemplary embodiment. As shown in the interface, a user has selected an initial dataset. A toggle switch for population normalization 601 is visible if the dataset has the option to population normalize and can be toggled between “#” for a map showing concentration based on volume and “%” for a map showing concentration based on per capita. By returning to the drop-down menu and selecting another data set, the current measure can be removed. Double clicking the text for an endpoint of the slider allows the user to edit it. Hitting <enter> then makes the change and the display updates. Also shown is a histogram-representation which renders a dot for each geographic area and animates it, expanding from its center baseline. Clicking and dragging over the top of it can set the filter min and max, and those endpoint can be edited later by hovering over the min or max area (the cursor will change) and then dragging to adjust. Target metrics are separated out from the measures, since they can depend on the combination or multiplication of multiple datasets. These mini graphs can lightly animate as they change. The impressions calculator can provide a toggle button (like the pointer and magnifying glass for the “geography” panel) which allows the user to switch between impressions and application targeting, which would show the list of applications that can be targeted.

FIG. 6C illustrates another user interface of the system according to an exemplary embodiment. In this interface the population normalization button has been toggled to “%” and the map and all metrics are computed with population normalization. In the figure, two buttons are shown which are used to control whether the user is in selection or zooming mode. The default can be zooming mode. The first click can zoom in on a state to show counties in more detail. The 2nd click can (if the data is available at the zip code level) zoom in further so the user can see zip code outlines. At that point click+drag can allow the user to pan the map around. If no data is available then the 2nd click can zoom back out, if zip data is available then the 3rd click can zoom all the way back out. If the user selects the pointer icon they can enter selection mode which allows for “regional” (such as state) level selection. In this mode, clicking on a state can select it or deselect it. The first click can deselect all other states and gray them out, allowing the user to build up from the state clicked first. The graph under the measures panel can update to reflect the new selection as well, so the user can see any effects on the number of targeted locations, the targeted rate and the target likelihood. Clicking outside the map area can reset the map to its selection status given the slider filter.

The system can also include interfaces to allow users to specify conditions, such as health conditions, healthcare plan conditions, drug coverage conditions, and various thresholds as described earlier. For example, a condition can be used to determine a percentage (or an index) of users that have a healthcare plan which covers a particular drug or a percentage (or an index) of users that have particular health condition. These conditions or measures can be stacked to identify a target geographic area, target drug, and/or target demographic as described earlier in the application and the results from applying these conditions can be shown in any of the interfaces described above, organized according to geographic areas.

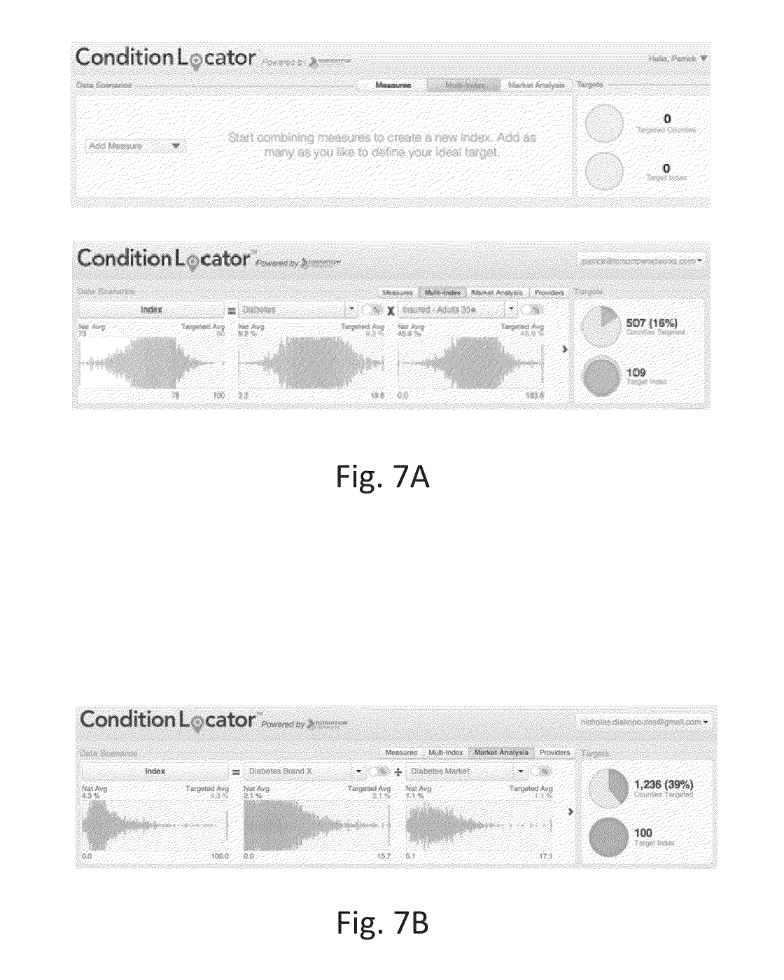

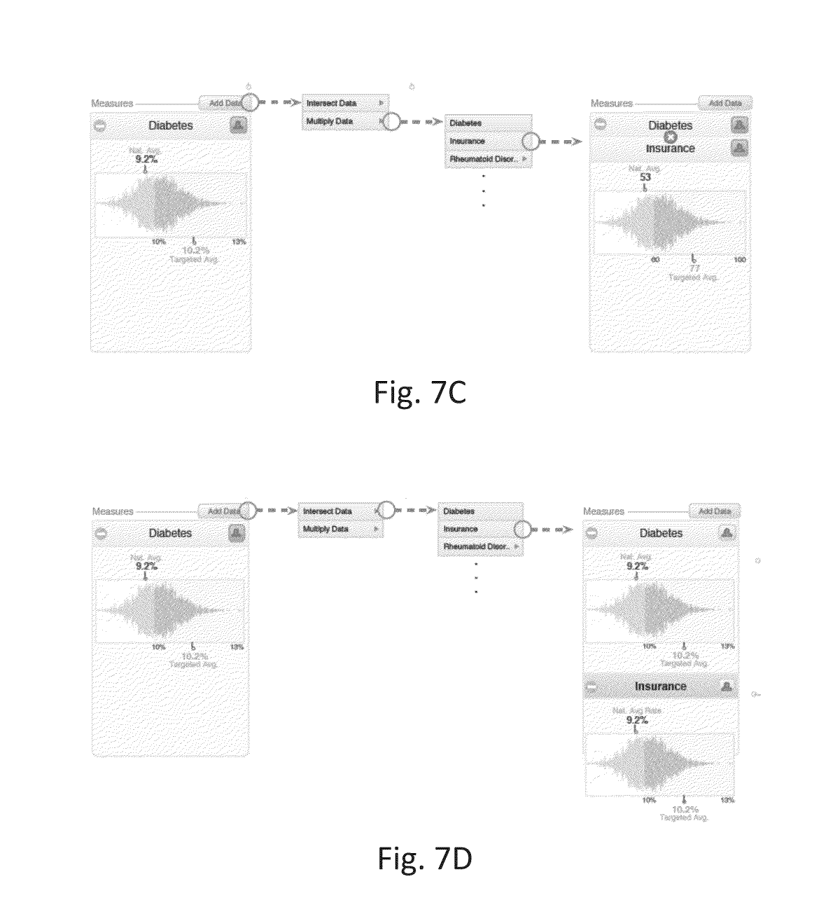

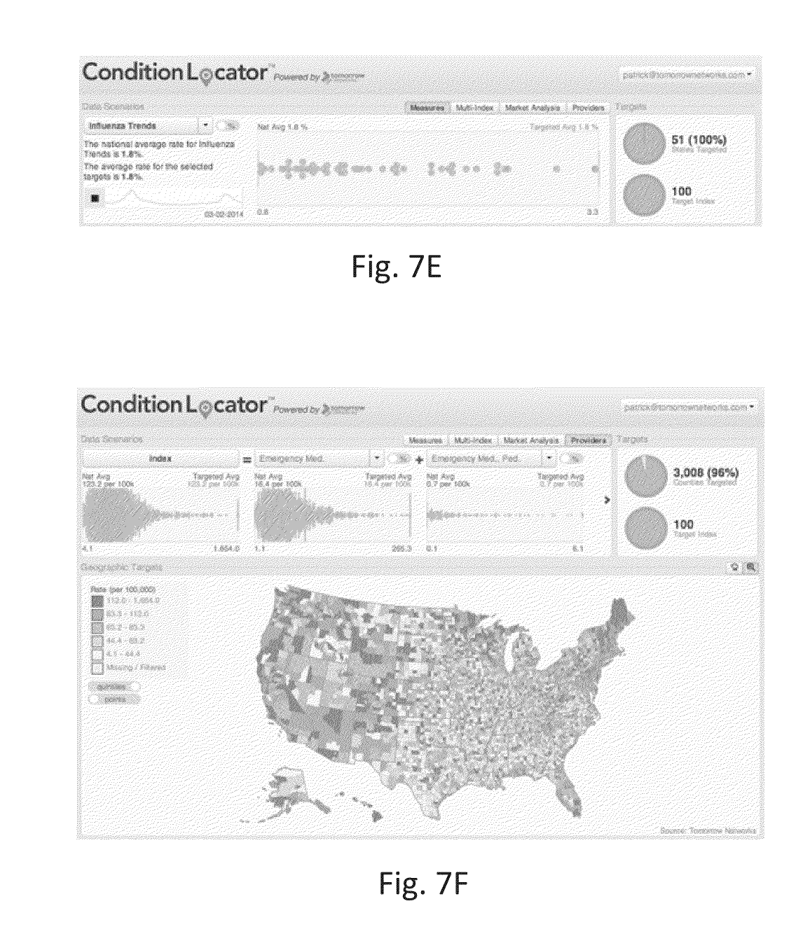

FIG. 7A illustrates another user interface of the system according to an exemplary embodiment. The interface illustrates a multi-index scenario which can be used in cases where the user wants to create a new index out of a set of measures. The user starts by adding a measure and continues to add more measures, each of which can be individually filtered. The final index can be the composition of all of the measures and can be determined by multiplying them (and log scaling and normalizing the numbers to be in the range of 0-100). In the interface shown, there are 3 histograms, one corresponding to the index, and two corresponding to two selected measures. The user can hover over this area to reveal a horizontal scroll bar that lets them move over and continue to add measures.

FIG. 7B illustrates another user interface of the system according to an exemplary embodiment. The figure illustrates a market analysis scenario which can be used for comparing a measure to a market basket (or another measure, if the market basket just contains 1 item). The user can add the measure, and then can add to the market basket. The user can continue to add to the market basket, or to change the measure for comparison. Hovering over the title of the measure can provide a drop down that allows the measure to be changed. Shown in the figure is a histogram comparing a brand to a market basket corresponding to a particular market. By dividing the brand distribution by the market distribution, a user can determine where the brand has higher or lower than average share of the particular market. The histograms concisely represent the geo-referenced data for each selected condition or measure.

FIG. 7C illustrates another user interface of the system according to an exemplary embodiment. In the interface shown, clicking the “add data” button reveals two options in a menu: “intersect data” or “multiply data”. In this interface, the user has chosen to “multiply” two datasets. They default to having equal weighting in the index. Also shown is a combined slider for the newly computed index which is scaled to 0-100. The user can continue to add or multiply datasets in this way.

FIG. 7D illustrates another user interface of the system according to an exemplary embodiment. In this interface, the user has added a dataset in parallel (to “intersect” it). Each dataset has its own selector slider which defines a min and max filter over that data. The combination (intersection) of those two sliders defines the # of targeted counties and the target likelihood shown in the targets panel. If the interface runs out of vertical space for multiple datasets, when the user hovers over the panel a scroll bar will appear so they can scroll down. Alternatively, each of the data graphs can be shrunk to make room. Since there are two datasets in parallel, the user can select one of them to get mapped. The darker color plus bold in “insurance” indicates that it is the selected data set. To change the selection the user can click on the label for the desired dataset. The selected dataset can be mirrored above the map as a label to reinforce which one is selected.

Of course, the functionality described in FIGS. 7C-7D can be carried out using other interfaces. For example, the interfaces shown in FIGS. 7A-7B can be utilized to intersect or multiply data, such as by selecting the multi-index button and selecting the multiple index values. Many variations and implementations of the multi-index measure are possible.

FIG. 7E illustrates another user interface of the system according to an exemplary embodiment. In the interface, a timeline is shown which has a play button. Clicking the play button can automatically step across each time period, for example at the rate of 1 every three seconds. This can update the map as it is played. If the user has already set min/max on the filter then those can remain consistent as the data plays through time. The steps can be adjusted. For example, if there are quarterly updates to some RX data, each quarter can be a time period in the timeline. Of course, other time periods are possible, such as days, weeks, months, or years.

FIG. 7F illustrates another user interface of the system according to an exemplary embodiment. In this interface the user has selected a dataset that has both density (population normalized) as well as explicit geolocations. The user can therefore toggle what is rendered on the map using the “%” and “#” toggle switch. If that switch is “%” then the map will render the density, whereas if it's “#,” then it will render a dot for each location. The user can still however select counties based on the density.

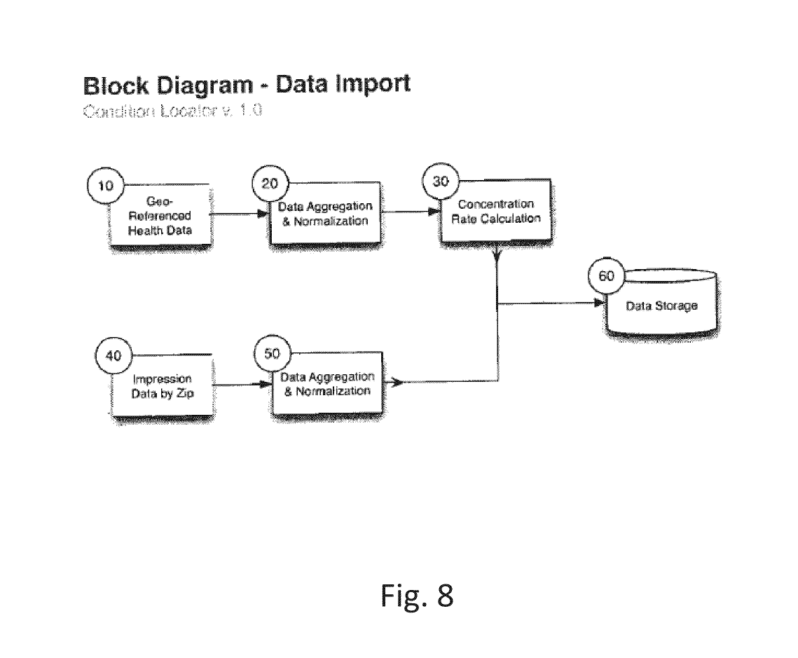

FIG. 8 illustrates a flowchart showing the data import process according to an exemplary embodiment. Geo-referenced health and demographic data (10) is input to the system from external sources. This data can be available for different geographic entities such as states, counties, or zip codes and in different units. According to the geographic entity available the data is then aggregated and normalized (20) to produce a population adjusted national average rate. For each geographic entity a concentration rate is then calculated (30) by dividing that entity's health data value by the population adjusted national average rate. This data can then be stored (68). Additionally, different data representing the number of impressions on an ad network (which can be broken down by gender, age, and geographic entity) for a given time span (40) is input to the system. This data can be aggregated from a zip code specific to county specific representation and normalized so that values reflect an idealized 30.5 day month (50). This data can then be stored in a database (60).

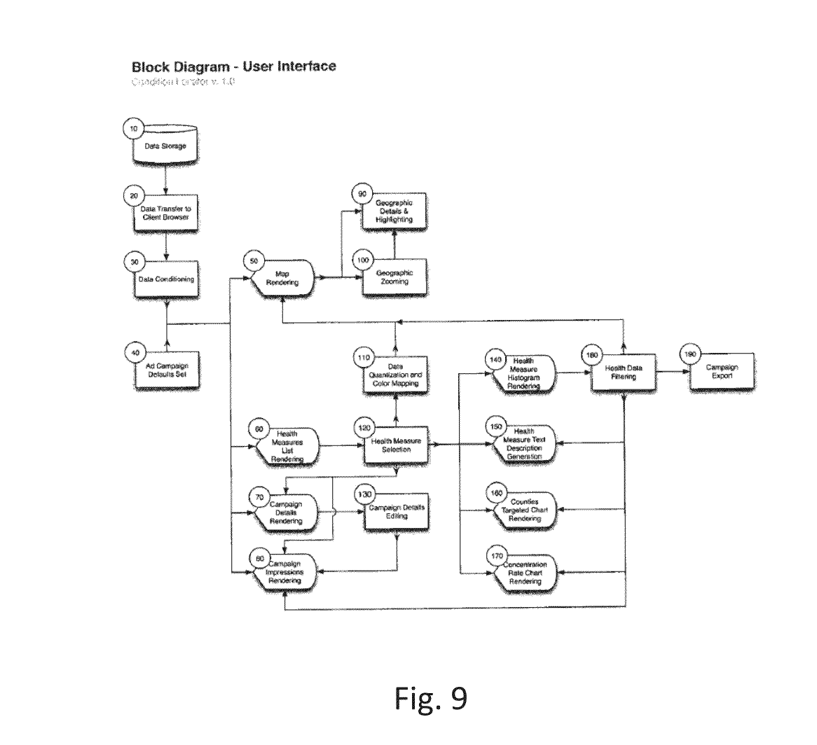

FIG. 9 illustrates a block diagram showing the user interface features according to an exemplary embodiment. Data stored as a result of the data import process (10) is transferred to the client (20) representing state and county health or demographic data as well as county ad impression data, and data representing the shapes of U.S. geographic entities including states and counties. Impression data can be conditioned to represent a predetermined percentage of itself so as not to oversell ad impression availability. For example, the impression data can be conditioned to represent 85% of itself.

Specific health data is then grouped by larger health issue such as “cancer” (30). Defaults campaign settings (e.g. duration, budget, cost per thousand impressions—CPM) are specified (40). A grayed version of a map of the U.S. showing state and county outlines is rendered (50); a listing of the available health data measures is rendered (60); campaign details reflecting defaults are rendered (70); and campaign impression counts are rendered using an animated split flat display (80). Selecting a health data measure (120) triggers a number of updates to the interface. The data is quantized using a kMeans algorithm and these quanta are mapped to a pre-selected color palette (110) whereby the map is then re-rendered (50) using the new color scheme to show the spatial distribution of the health data. A health measure histogram is then rendered by depicting the frequency of the health measure quantized into 20 equal bins (140). Text which describes the national average and average for the selected geography is generated from the data (150). A pie chart indicating the number and percentage of geographic entities targeted is rendered (180). A concentration index chart is rendered (170) by averaging the population adjusted concentration rates for the targeted geographic entities. The health data can be filtered (180) which triggers re-rendered updates to (150, 160, 170, 50, and 80). Editing of the campaign details (130) updates the split flap display of campaign impressions: (80). Interaction with the map is supported by hovering over different geographic entities (90) which reveals an information display showing the health data rate, impressions available, and concentration index for that entity; and by clicking on the map which triggers a zoomed in view of the geographic entity (100). After adjusting the campaign and filters a description of the campaign may be exported for further processing (190).

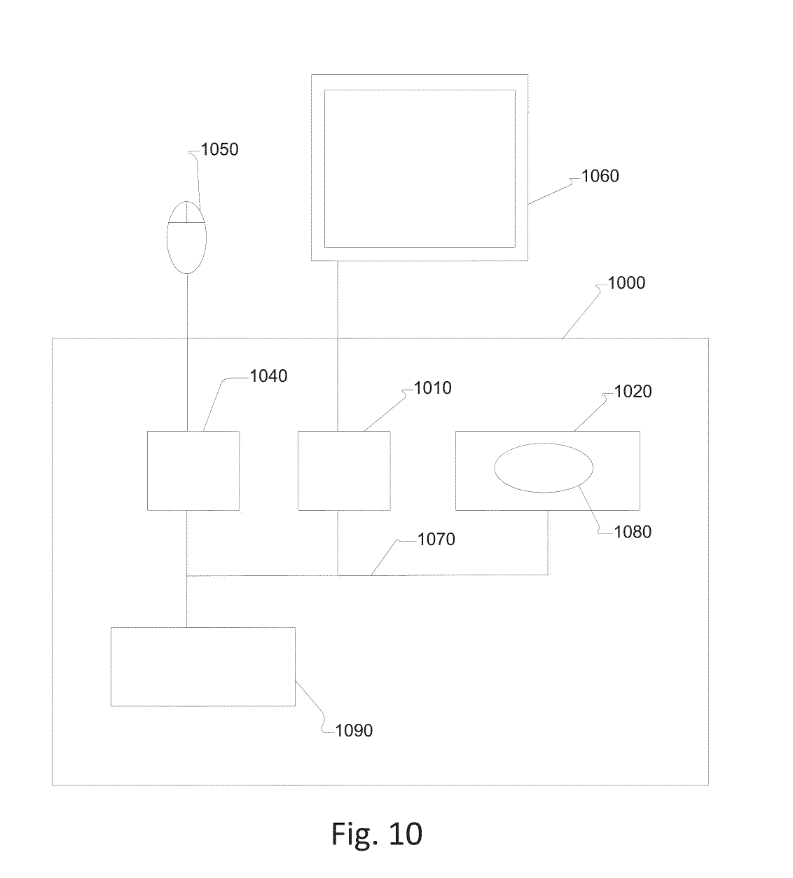

One or more of the above-described techniques can be implemented in or involve one or more computer systems. FIG. 10 illustrates a generalized example of a computing environment 1000. The computing environment 1000 is not intended to suggest any limitation as to scope of use or functionality of a described embodiment.

With reference to FIG. 10, the computing environment 1000 includes at least one processing unit 1010 and memory 1020. The processing unit 1010 executes computer-executable instructions and may be a real or a virtual processor. In a multi-processing system, multiple processing units execute computer-executable instructions to increase processing power. The memory 1020 may be volatile memory (e.g., registers, cache, RAM), non-volatile memory (e.g., ROM, EEPROM, flash memory, etc.), or some combination of the two. The memory 1020 may store software instructions 1080 for implementing the described techniques when executed by one or more processors. Memory 1020 can be one memory device or multiple memory devices.

A computing environment may have additional features. For example, the computing environment 1000 includes storage 1040, one or more input devices 1050, one or more output devices 1060, and one or more communication connections 1090. An interconnection mechanism 1070, such as a bus, controller, or network interconnects the components of the computing environment 1000. Typically, operating system software or firmware (not shown) provides an operating environment for other software executing in the computing environment 1000, and coordinates activities of the components of the computing environment 1000.

The storage 1040 may be removable or non-removable, and includes magnetic disks, magnetic tapes or cassettes, CD-ROMs, CD-RWs, DVDs, or any other medium which can be used to store information and which can be accessed within the computing environment 1000. The storage 1040 may store instructions for the software 1080.

The input device(s) 1050 may be a touch input device such as a keyboard, mouse, pen, trackball, touch screen, or game controller, a voice input device, a scanning device, a digital camera, remote control, or another device that provides input to the computing environment 1000. The output device(s) 1060 may be a display, television, monitor, printer, speaker, or another device that provides output from the computing environment 1000.

The communication connection(s) 1090 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1000, computer-readable media include memory 1020, storage 1040, communication media, and combinations of any of the above.

Of course, FIG. 10 illustrates computing environment 1000, display device 1060, and input device 1050 as separate devices for ease of identification only. Computing environment 1000, display device 1060, and input device 1050 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1000 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the disclosure and equivalents thereto.

What is claimed is:

1. A method executed by one or more computing devices for determining a target geographic area for a target drug, the method comprising:
receiving, by at least one of the one or more computing devices, health condition information for a plurality of geographic areas, wherein the health condition information includes information regarding one or more health conditions of residents in each of the plurality of geographic areas;
receiving, by at least one of the one or more computing devices, healthcare plan information corresponding to each geographic area in the plurality of geographic areas, wherein the healthcare plan information includes formulary information corresponding to at least a subset of the residents in each of the plurality of geographic areas, the formulary information specifying the availability of one or more of drugs;
determining, by at least one of the one or more computing devices, the target geographic area for the target drug from the plurality of geographic areas, wherein the target geographic area is determined based at least in part on a combination of the health condition information and the formulary information; and
transmitting, by at least one of the one or more computing devices, a representation of the target geographic area.

2. The method of claim 1, wherein the one or more potential consumers in the target geographic area are selected from a plurality of potential consumers in the target geographic area based at least in part on demographic information.

3. The method of claim 1, wherein each geographic area in the plurality of geographic areas corresponds to one of a state, a county, a zip code, an address, a facility, and a city.

4. The method of claim 1, wherein the target geographic area is also determined based at least in part on a total number of available ad impressions for that target geographic area.

5. The method of claim 1, wherein determining a target geographic area from the plurality of geographic areas comprises:
determining a first percentage of residents that have a target health condition in the one or more health conditions for each geographic area in the plurality of geographic areas, wherein the first percentage is based at least in part on the received health condition information and wherein the target drug is designed to treat the target health condition; and
identifying one or more potential target geographic areas based at least in part on a determination that the corresponding first percentage of residents that have the target health condition for that geographic area is greater than a first predetermined threshold.

6. The method of claim 5, wherein the target health condition is provided by a user via a user interface.

7. The method of claim 5, further comprising:
transmitting, by at least one of the one or more computing devices, a map of the plurality of geographic areas, wherein the map includes indicators corresponding to the first percentage for each geographic area in the plurality of geographic areas.

8. The method of claim 5, wherein determining a target geographic area from the plurality of geographic areas further comprises:
determining a second percentage of residents in each of the one or more potential target geographic areas that have a healthcare plan which covers the target drug, wherein the second percentage is based at least in part on the formulary information; and
designating one of the one or more potential target geographic areas as the target geographic area based at least in part on a determination that the second percentage is greater than a second predetermined threshold.

9. The method of claim 5, wherein the first predetermined threshold and the second predetermined threshold are provided by a user via a user interface.

10. The method of claim 1, further comprising transmitting, by at least one of the one or more computing devices, an advertisement for the target drug to one or more potential consumers in the target geographic area.

11. A system for determining a target geographic area for a target drug, the system comprising:
one or more processors; and
one or more memories operatively coupled to at least one of the one or more processors and having instructions stored thereon that, when executed by at least one of the one or more processors, cause at least one of the one or more processors to:
receive health condition information for a plurality of geographic areas, wherein the health condition information includes information regarding one or more health conditions of residents in each of the plurality of geographic areas;
receive healthcare plan information corresponding to each geographic area in the plurality of geographic areas, wherein the healthcare plan information includes formulary information corresponding to at least a subset of the residents in each of the plurality of geographic areas, the formulary information specifying the availability of one or more of drugs;
determine the target geographic area for the target drug from the plurality of geographic areas, wherein the target geographic area is determined based at least in part on a combination of the health condition information and the formulary information; and
transmit a representation of the target geographic area.

12. The system of claim 11, wherein the one or more potential consumers in the target geographic area are selected from a plurality of potential consumers in the target geographic area based at least in part on demographic information.

13. The system of claim 11, wherein each geographic area in the plurality of geographic areas corresponds to one of a state, a county, a zip code, an address, a facility, and a city.

14. The system of claim 11, wherein the target geographic area is also determined based at least in part on a total number of available ad impressions for that target geographic area.

15. The system of claim 11, wherein the instructions that, when executed by at least one of the one or more processors, cause at least one of the one or more processors to determine a target geographic area from the plurality of geographic areas further cause at least one of the one or more processors to:
determine a first percentage of residents that have a target health condition in the one or more health conditions for each geographic area in the plurality of geographic areas, wherein the first percentage is based at least in part on the received health condition information and wherein the target drug is designed to treat the target health condition; and
identify one or more potential target geographic areas based at least in part on a determination that the corresponding first percentage of residents that have the target health condition for that geographic area is greater than a first predetermined threshold.

16. The system of claim 15, wherein the target health condition is provided by a user via a user interface.

17. The system of claim 15, wherein at least one of the one or more memories has further instructions stored thereon that, when executed by at least one of the one or more processors, cause at least one of the one or more processors to:
transmit a map of the plurality of geographic areas, wherein the map includes indicators corresponding to the first percentage for each geographic area in the plurality of geographic areas.

18. The system of claim 15, wherein the instructions that, when executed by at least one of the one or more processors, cause at least one of the one or more processors to determine a target geographic area from the plurality of geographic areas further cause at least one of the one or more processors to:
determine a second percentage of residents in each of the one or more potential target geographic areas that have a healthcare plan which covers the target drug, wherein the second percentage is based at least in part on the formulary information; and
designate one of the one or more potential target geographic areas as the target geographic area based at least in part on a determination that the second percentage is greater than a second predetermined threshold.

19. The system of claim 15, wherein the first predetermined threshold and the second predetermined threshold are provided by a user via a user interface.

20. The system of claim 11, wherein at least one of the one or more memories has further instructions stored thereon that, when executed by at least one of the one or more processors, cause at least one of the one or more processors to:
transmit an advertisement for the target drug to one or more potential consumers in the target geographic area.

21. At least one non-transitory computer-readable medium storing computer-readable instructions that, when executed by one or more computing devices, cause at least one of the one or more computing devices to:
receive health condition information for a plurality of geographic areas, wherein the health condition information includes information regarding one or more health conditions of residents in each of the plurality of geographic areas;
receive healthcare plan information corresponding to each geographic area in the plurality of geographic areas, wherein the healthcare plan information includes formulary information corresponding to at least a subset of the residents in each of the plurality of geographic areas, the formulary information specifying the availability of one or more of drugs;
determine the target geographic area for the target drug from the plurality of geographic areas, wherein the target geographic area is determined based at least in part on a combination of the health condition information and the formulary information; and
transmit a representation of the target geographic area.

22. The at least one non-transitory computer-readable medium of claim 21, wherein the one or more potential consumers in the target geographic area are selected from a plurality of potential consumers in the target geographic area based at least in part on demographic information.

23. The at least one non-transitory computer-readable medium of claim 21, wherein each geographic area in the plurality of geographic areas corresponds to one of a state, a county, a zip code, an address, a facility, and a city.

24. The at least one non-transitory computer-readable medium of claim 21, wherein the target geographic area is also determined based at least in part on a total number of available ad impressions for that target geographic area.

25. The at least one non-transitory computer-readable medium of claim 21, wherein the instructions that, when executed by at least one of the one or more computing devices, cause at least one of the one or more computing devices to determine a target geographic area from the plurality of geographic areas further cause at least one of the one or more computing devices to:
determine a first percentage of residents that have a target health condition in the one or more health conditions for each geographic area in the plurality of geographic areas, wherein the first percentage is based at least in part on the received health condition information and wherein the target drug is designed to treat the target health condition; and
identify one or more potential target geographic areas based at least in part on a determination that the corresponding first percentage of residents that have the target health condition for that geographic area is greater than a first predetermined threshold.

26. The at least one non-transitory computer-readable medium of claim 25, wherein the target health condition is provided by a user via a user interface.

27. The at least one non-transitory computer-readable medium of claim 25, further storing computer-readable instructions that, when executed by at least one of the one or more computing devices, cause at least one of the one or more computing devices to:
transmit a map of the plurality of geographic areas, wherein the map includes indicators corresponding to the first percentage for each geographic area in the plurality of geographic areas.

28. The at least one non-transitory computer-readable medium of claim 25, wherein the instructions that, when executed by at least one of the one or more computing devices, cause at least one of the one or more computing devices to determine a target geographic area from the plurality of geographic areas further cause at least one of the one or more computing devices to:
determine a second percentage of residents in each of the one or more potential target geographic areas that have a healthcare plan which covers the target drug, wherein the second percentage is based at least in part on the formulary information; and
designate one of the one or more potential target geographic areas as the target geographic area based at least in part on a determination that the second percentage is greater than a second predetermined threshold.

29. The at least one non-transitory computer-readable medium of claim 25, wherein the first predetermined threshold and the second predetermined threshold are provided by a user via a user interface.

30. The at least one non-transitory computer-readable medium of claim 21, further storing computer-readable instructions that, when executed by at least one of the one or more computing devices, cause at least one of the one or more computing devices to:
transmit an advertisement for the target drug to one or more potential consumers in the target geographic area.
